(19) United States
(12) Patent Application Publication
(10) Pub. No.: US 2008/0081316 A1
(43) Pub. Date: Apr. 3, 2008

(54) Fixture

(75) Inventor: Sung Min Chung, Seoul (KR)

Correspondence Address: ST. ONGE STEWARD JOHNSTON & REENS, LLC, 986 BEDFORD STREET, STAMFORD, CT, 06905-5619, US

(73) Assignee: BIOMEDICARE, Inc. Cypress, CA

(21) Appl. No.: 11/529,410

(22) Filed: Sep. 28, 2006

(51) Int. Cl. A61C 8/00

(52) U.S. Cl. 433/174

(57) ABSTRACT

A fixture is disclosed, in which a small thread part is formed at an upper side of a fixture, and a large thread part is formed at a lower side of the same, with the leads of the small and large thread parts being same, and with the small thread parts being not overlapped with each other, and with at least two thread parts being formed. When implanting a fixture into an alveolar bone, a cancellous bone with a smooth tissue contacts with a large tread portion of the fixture, so that an engagement force is enhanced. An alveolar bone contacts with a small thread part of the fixture, so that an engagement is enhanced. A bone destroy is prevented by continuously providing a certain stimulation to an alveolar bone. The fixture is stably fixed based on multi-step small thread parts. Since an upper side of the fixture is formed with a certain inclination, mixing of smooth tissue is basically prevented. A cut groove is formed at a lower side of the fixture for a self-tapping of the fixture.

### FIELD OF THE INVENTION

The present invention relates to a fixture, which becomes a root of an artificial tooth as an upper structure is mounted thereon, and in particular to an improved fixture in which an engagement with an alveolar bone, a basic function of a fixture, is more enhanced, and a sealing and anti-rotation function with respect to an upper structure is significantly enhanced.

### BACKGROUND OF THE INVENTION

A dental implant is a kind of an implant device formed of a foreign substance molding material implanted into a mouth tissue such as a mucosa or a lower side of a periosteum and an interior of a bone tissue. The dental implant is implanted on or into a jaw so as to support a temporal type or fixed type implant. The dental implant is classified into a fin shape, a screw shape, a cylinder shape, a blade shape, a basket shape or a tooth root shape based on their outer shapes or geometrical shapes. Generally, the dental implant is closely related with a bone which provides a support and safety and is classified based on its fixing element. The dental implant is further classified into an eposteal dental implant, an endosteal dental implant and a transosteal dental implant. Some implants have the same eposteal and endosteal elements.

In the case of the dental implant, a fixture is the most important element, which may be actually called an implant. The fixture is implanted into an alveolar bone using threads. The fixture is integrated with a contacting bone and is stably fixed after it is implanted. The alveolar bone is formed of a hard compact bone, and the lower side of the same is formed of a smooth cancellous bone. According to the Korean patent registration No. 473141 of “Dental implant”, as shown in FIG. 1, the dental implant has threads formed in the same shape from an upper side to a lower side. Since the threads are continuously formed, an engaging area between the fixture and the alveolar bone is small, and the engaging force with the alveolar bone is weak, so that an initial fixing property of the fixture is bad. With no stimulations at the compact bone, the bone may be easily broken.

The present invention is directed to an artificial tooth system. In addition, the present invention is directed to a fixture having a body directly implanted into an alveolar bone, and an abutment formed on an upper side of the same, with an upper structure being mounted on the same.

Here, the implant may be classified into an implant in which an operation is finished with a first procedure in which a tooth root shaped metal is implanted into a jaw, and an implant in which a prosthesis therapy is performed after first and second operations are performed. In the twice implant operations, the fixture of the implant is implanted into the jawbone through a first surgical operation. In the second surgical operation, after three or six months are passed so that bone tissues are integrated with the implanted implant, the final prosthesis is connected with the implant. In this case, the patients should endure many inconveniences after the implant is implanted. In addition, since the surgical operation is performed twice, the patients suffer from psychological and economical loads. The surgical operations are very complicated.

### SUMMARY OF THE INVENTION

Accordingly, it is an object of the present invention to provide a fixture which overcomes the above-described problems encountered in the conventional art.

It is another object of the present invention to provide a fixture in which a small thread part is formed at an upper side of a fixture, and a large thread part is formed at a lower side of the same, with the leads of the small and large thread parts being same, and with the small thread parts being not overlapped with each other, and with at least two thread parts being formed. When implanting a fixture into an alveolar bone, a cancellous bone with a smooth tissue contacts with a large tread portion of the fixture, so that an engagement force is enhanced. An alveolar bone contacts with a small thread part of the fixture, so that an engagement is enhanced. A bone destroy is prevented by continuously providing a certain stimulation to an alveolar bone. The fixture is stably fixed based on multi-step small thread parts. Since an upper side of the fixture is formed with a certain inclination, mixing of smooth tissue is basically prevented. A cut groove is formed at a lower side of the fixture for a self-tapping of the fixture.

Another objects according to the present invention is to provide the fixing body which available to install on an alveolus bone with a small screw thread tooth, the first, second thread large teeth or the third thread tooth which formed as a figure of emboss, formed on the fixing body, instantly.

It is further another object of the present invention to provide an instant function fixture for a dental purpose in which an abutment is integral for a direct implantation after a corresponding tooth is removed.

To achieve the above objects, in a fixture which becomes a root of an artificial tooth as an upper structure is mounted on the fixture, there is provided an improved fixture, comprising a first inclination part which has a 3° inclination angle from an upper side to a lower side and has a small thread part at an outer surface of the same and is engaged with a compact bone; a non-tooth part which is extended from an upper end of the first inclination part and has a certain upward inclination angle, with the upper structure being mounted thereon; a straight part which is extended from a lower end of the first inclination part and has a first large thread part formed at an outer surface of the same and having the same lead as the small thread part and is engaged with a cancellous bone; a second inclination part which is extended from a lower end of the straight part and has a certain downward inclination angle and has the same lead as the small thread part, and a cut groove formed at an outer surface in which the second large thread part is formed, with the second inclination part being engaged with the cancellous bone; an inclination groove part which has a 11° inclination angle from an inner upper side of the non-tooth part to an inner lower side of the first inclination part and has an inclination groove in which the upper structure is mounted, and a hexagonal part formed at a lower side of the groove and prevents the rotation of the upper structure; a straight groove part which is extended from a lower end of the inclination groove part and supports the upper structure; and a thread groove part which is extended from a lower end of the straight groove part and is thread-engaged with the threads of the upper structure.

To achieve the above objects, in a fixture which becomes a root of an artificial tooth as an upper structure is mounted on the fixture, there is provided an improved fixture, comprising a first straight part which has two small thread parts at an outer surface of the same and is engaged with a compact bone; a non-tooth part which is extended from an upper end of the first straight part, with a diameter of the same getting decreased in an upward direction, and with the upper structure being mounted thereon; a first inclination part which is extended from a lower end of the first straight part and has a first large thread part formed at an outer surface and having the same lead as the small thread part and is engaged with a cancellous bone; a second straight part which is extended from a lower end of the first inclination part and has a second large thread part having the same lead as the small thread part and is engaged with a cancellous bone; a second inclination part which is extended from a lower end of the second straight part and has a third large thread part having the same lead as the small thread part and a cut groove formed at an outer surface in which the third large thread part is formed and is engaged with a cancellous bone; an inclination groove part which has an inclination groove formed from an inner upper side of the non-tooth part to an inner lower side of the first inclination part, with the upper structure being mounted thereon, and a hexagonal part formed at a lower side of the groove for thereby preventing the rotation of the upper structure; a straight groove part which is extended from a lower end of the inclination groove part and support the upper structure; and a thread groove part which is extended from a lower end of the straight groove part and is thread-engaged with the threads of the upper structure.

To achieve the above objects, in a fixture which becomes a root of an artificial tooth as an upper structure is mounted on the fixture, there is provided an improved fixture, comprising a head part which includes a first inclination part extended with a diameter of the same getting decreased in an upward direction, and a second inclination part extended from a lower end of the first inclination part, with a diameter of the same getting decreased in a downward direction; a third inclination part which is extended from a lower end of the second inclination part and has a small thread part formed at an outer surface of the same and is engaged with a compact bone; a straight part which is extended from a lower end of the third inclination part and has a first large thread part having the same lead as the small thread part and is engaged with a cancellous bone; a fourth inclination part which is extended from a lower end of the straight part and has a second large thread part formed at an outer surface of the same and having the same lead as the small thread part and a cut groove formed at an outer surface in which the second large thread part is formed and is engaged with a cancellous bone; an inclination groove part which is formed with a diameter getting decreased from an inner upper side of the first inclination part to an inner lower side of the second inclination part and includes an inclination groove in which the upper structure is mounted and a hexagonal part formed at a lower side of the groove for thereby preventing the rotation of the upper structure; and a thread groove part which is extended from a lower end of the inclination groove part and is engaged with the threads of the upper structure.

To achieve the above objects, in a fixture which is implanted into an alveolar and becomes a root of an artificial tooth, with an upper structure being mounted thereon, there is provided a fixture, comprising an abutment part which is formed upwards with a diameter of the same getting decreased, and includes a first inclination part having at least plane surfaces at an upper outer surface and a second inclination part extended from a lower end of the first inclination part, with a diameter of the same getting decreased downwards; a third inclination part which is extended from a lower end of the second inclination part and has a small thread part at an outer surface of the same and is engaged with a compact bone; a straight part which is extended from a lower end of the third inclination part and has a first large thread part having the same lead as the small thread part and is engaged with a cancellous bone; and a fourth inclination part which is extended from a lower end of the straight part and has a second large thread part formed at an outer surface and having the same lead as the small thread part and a cut groove formed at an outer surface, in which the second large thread part is formed, and is engaged with a cancellous bone.

In a fixing body which role as an artificial dental root that, implants on the alveolar bone to mount the upper construction; A cylinder member formed and extending in a same diameter to the direction of upper portion and, a head member having a corolla figured second incline member which configured the diameter thereof is decreased from the bottom of the cylinder member which extending, to the direction of the lower part thereof; The third inclined member extends from the bottom of second inclined member, the small thread teeth formed on the peripherals thereof, and jointed with the fine bone; The rectilinear member extends from the lower end of third inclined member, the first large thread teeth having a same lead with the small thread teeth formed on the peripheral surface and coupled with a sponge bone; The second large thread teeth extends from the lower end of the rectilinear member, and formed a same lead with the small thread teeth on the peripherals thereof, the forth inclined member includes the cutting groove formed on the on the peripheral surface which formed the second large thread teeth and, coupled with a sponge bone; The hexagon member is configured as a protruded form on the direction of upper side of the head member, in the state of completely coupled with the upper structure, without produce a revolution, the protruded outer surface is formed as polygon configured of a hexagon body, and penetrate to the inside of the hexagon body thus, includes of which formed the grooves extends to the second inclined member; and, The thread groove member extends from the lower end of the hexagon member, coupled with the fixing screw on the upper side of the upper structure.

### BRIEF DESCRIPTION OF THE DRAWINGS

The present invention will become better understood with reference to the accompanying drawings which are given only by way of illustration and thus are not limitative of the present invention, wherein;

FIG. 1 is a front perspective view illustrating a conventional dental implant;

FIG. 2 is a front perspective view illustrating a fixture according to a first embodiment of the present invention;

FIG. 3 is a cross sectional view taken along line A-A′ of FIG. 2;

FIG. 4 is a view illustrating a use state of a fixture according to a first embodiment of the present invention;

FIG. 5 is a graph of an experiment data of a fixture according to a first embodiment of the present invention;

FIG. 6 is a front perspective view illustrating a fixture according to a second embodiment of the present invention;

FIG. 7 is a cross sectional view taken along line B-B′ of FIG. 6;

FIG. 8 is a view illustrating a use state of a fixture according to a second embodiment of the present invention;

FIG. 9 is a front perspective view illustrating a fixture according to a third embodiment of the present invention;

FIG. 10 is a cross sectional view taken along line C-C′ of FIG. 9;

FIG. 11 is a view illustrating a use state of a fixture according to a third embodiment of the present invention;

FIG. 12 is a front perspective view illustrating a fixture according to a fourth embodiment of the present invention;

FIG. 13 is a cross sectional view taken along line D-D′ of FIG. 12;

FIG. 14 is a view illustrating a use state of a fixture according to a fourth embodiment of the present invention;

FIG. 15 is a front perspective view shows the fixing body according to the fifth embodiment of the present invention;

FIG. 16 is a view shows in another direction of the fixing body according to the fifth embodiment of the present invention; and

FIG. 17 is a view on a use state in detail of the fixing body according to the fifth embodiment of the present invention.

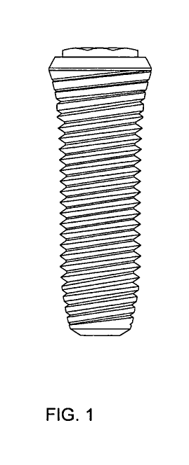

### DETAILED DESCRIPTION OF THE INVENTION

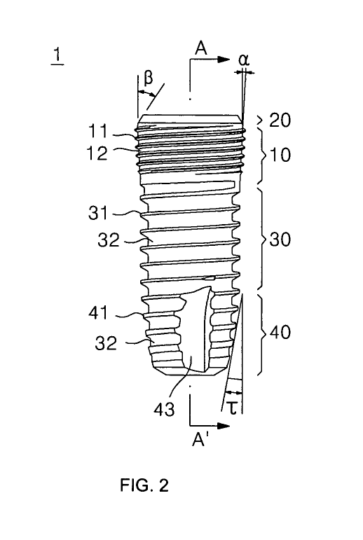

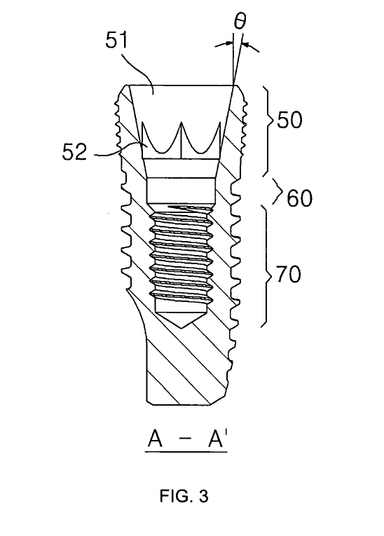

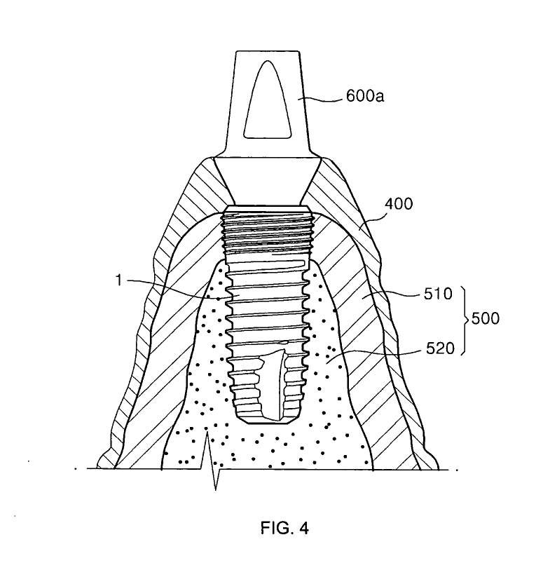

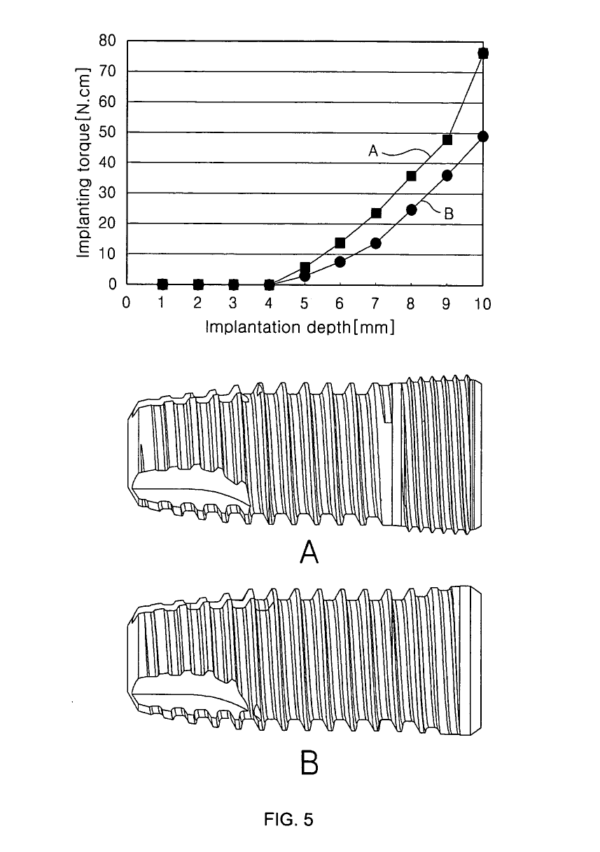

FIG. 2 is a front perspective view illustrating a fixture according to a first embodiment of the present invention, FIG. 3 is a cross sectional view taken along line A-A′ of FIG. 2, FIG. 4 is a view illustrating a use state of a fixture according to a first embodiment of the present invention, and FIG. 5 is a graph of an experiment data of a fixture according to a first embodiment of the present invention. The fixture 1 according to the present invention comprises a first inclination part 10, a non-tooth part 20, a straight part 30, a second inclination part 40, an inclination groove part 50, a straight groove part 60, and a thread groove part 70.

Here, the first inclination part 10 is formed at a 2˜4° angle from an upper side to a lower side, preferably at a 3° angle. At least two small thread parts 11 are formed at an outer surface of the same. A straight groove 12 is formed between the neighboring small thread parts 11 in an axial direction. The small thread part 11 has the same lead as a large thread part (which will be described later), so that the first inclination part 10 and the compact bone 510 are thread-engaged, for thereby obtaining a tight and stable engagement with the compact bone 510. With this construction, a bone destroy is prevented by continuously providing stimulations to the compact bone 510. The axial direction straight groove 12 is engaged over an area wider than the small thread part 11, so that an engagement force between the fixture 1 and the compact bone 510 is more enhanced.

The non-tooth part 20 is extended from an upper end of the first inclination part 10 in an upward direction at an inclination angle (β) of 15˜45°, so that an upper structure 600a is mounted thereon. The non-tooth part 20 allows a surplus compact bone 500 not to form during a first surgical operation and a second surgical operation. The non-tooth part 20 prevents the surplus alveolar bone 500 from being attached on an upper side of the fixture 1. Here, the non-tooth part 20 is only one structure, which is protruded outwards from the alveolar bone 500 after the fixture 1 is implanted, and is preferably smaller than the entire length of the fixture 1.

The straight part 30 is extended from a lower end of the first inclination part 10. A first large thread part 31 having the same lead as the small thread part 11 is formed at an outer surface of the straight part 30, so that the straight part 30 is engaged with a cancellous bone 520. An axial direction straight groove 32 is formed between the first large thread parts 31. The axial direction straight groove 32 is engaged over an area wider than the first large thread part 31, so that an engagement force between the fixture 1 and the cancellous bone 520 is more enhanced.

The second inclination part 40 is extended from a lower end of the straight part 30 at an inclination angle (τ) 8˜15° in a downward direction. The second inclination part 40 includes a second large thread part 41 formed at an outer surface of the same and having the same lead as the small thread part 11, and a cut groove 43 which is symmetrically formed at an outer surface in which the second large part 41 is formed, so that the second inclination part 40 is engaged with the cancellous bone 520. The second inclination part 40 first contacts with the alveolar bone 500 when it is implanted into the alveolar bone 500. Here, the cut groove 43 performs a self-tapping when the fixture 1 is implanted into the alveolar bone 500. Three cut grooves are preferably formed at an outer surface of the second inclination part 40. An axial direction straight groove 32 is formed between the second large thread parts 41. The axial direction straight groove 32 is engaged over an area wider than the second large thread part 41, so that an engagement force between the fixture 1 and the cancellous bone 520 is more enhanced.

The inclination groove part 50 is formed in the interior of the fixture 1 and includes a groove 51 inclined at an angle (θ) 11° from the inner upper side of the non-tooth part 20 to the inner lower side of the first inclination part 10 so that the upper structure 600a is mounted thereon, and a hexagonal part 52 which is formed at the groove 51 for preventing the rotation of the upper structure 600a. Here, the inclination groove part 50 is formed with a certain height corresponding to the first inclination part 10. The hexagonal part 52 is preferably formed in a polygonal shape such as hexagonal shape, an octagonal shape, or a 12-angle shape. The hexagonal part 52 substantially prevents the movement of the upper structure 600a after the upper structure 600a is engaged.

The straight groove part 60 is extended from the lower end of the inclination groove part 50 and connects the inclination groove part 50 and the thread groove part 70 (which will be described later).

The thread groove part 70 is extended from the lower end of the straight groove part 60, with the threads of the upper structure 600a being engaged with the thread groove part 70.

Since, the small tooth 11 and the first and second large teeth 31, 41 are formed as emboss, available to install on the alveolus bone, instantly.

FIG. 4 is a view illustrating a use state of a fixture according to a first embodiment of the present invention, and FIG. 5 is a graph of an experiment data of a fixture according to a first embodiment of the present invention.

First, a hole is formed at a portion of the alveolar bone 500 using a drilling machine (not shown), with the fixture 1 being implanted into the portion of the alveolar bone 500. The fixture 1 is implanted into the alveolar bone 500 using a hand piece (not shown). The thusly formed hole has a diameter corresponding to the diameter of the grooved portion of the thread part of the fixture 1, so that the fixture 1 is thread-engaged with the alveolar bone 500. A part of the alveolar bone 500 from a gum is formed of the compact bone 510. The inner portion of the alveolar bone is formed of a smooth cancellous bone 520. When the fixture 1 is implanted into the alveolar bone 500, the second inclination part 40 and the straight part 30 contact with the smooth cancellous bone 520, and the first inclination part 10 contacts with the compact bone 510. With the above construction, since the cancellous bone 520 contacts with the large thread part over wider areas, the engagement force can be enhanced. The small thread part 11 may be tightly and stably engaged with the compact bone 510. Since at least two small thread parts 11 are provided, the contacting area with the compact bone 510 becomes wider for thereby enhancing an engagement force. When chewing foods after all surgical operations are finished, continuous stimulations are provided to the alveolar bone 500, so that it is possible to prevent the destroy of bone. The upper structure 600a is mounted on the upper side of the fixture 1. As shown in FIG. 5, when the fixture according to a first embodiment of the present invention is implanted into the alveolar bone using a drilling machine, the experimental data are obtained by comparing the implanting torque [N.cm] applied to the fixture based on the implantation depth [mm]. The implantation force according to the present invention (A) having small thread parts is relatively large as compared to the conventional art (B) in which the small thread parts are not provided. The small thread parts are tightly and stably engaged at the compact bone, so that the compact bone has a uniform stress distribution. As a result, the present invention (A) has an improved initial fixing effect of the fixture as compared to the conventional art (B). The experimental data with respect to the small thread parts are adapted to other embodiments of the present invention.

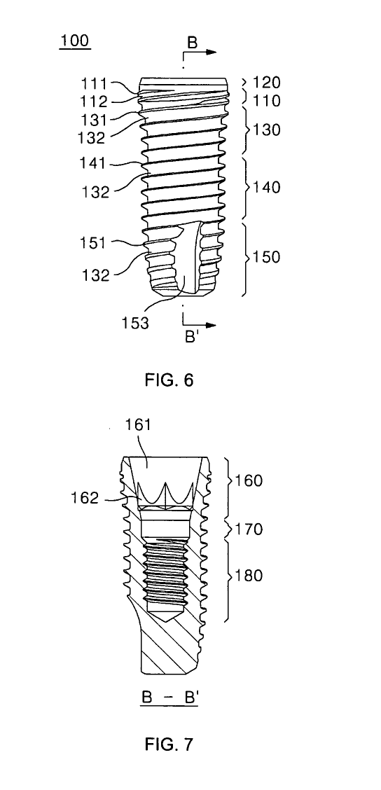

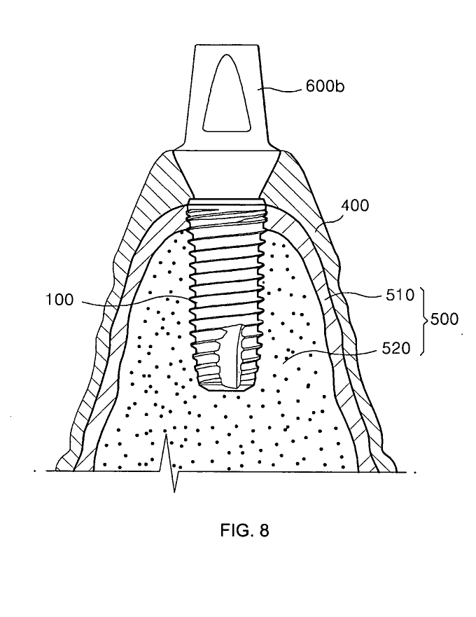

FIG. 6 is a front perspective view illustrating a fixture according to a second embodiment of the present invention, FIG. 7 is a cross sectional view taken along line B-B′ of FIG. 6, and FIG. 8 is a view illustrating a use state of a fixture according to a second embodiment of the present invention. The fixture 100 according to the present invention comprises a first straight part 110, a non-tooth part 120, a first inclination part 130, a second straight part 140, a second inclination part 150, an inclination groove part 160, a straight groove part 170, and a thread groove part 180.

Two small thread parts 111 are formed at an outer surface of the first straight part 110. The first straight part 110 is engaged with the compact bone 510. With two small thread parts 111, the inclination of the first inclination part 130 is maintained. The first straight part 110 is tightly and stably engaged with the compact bone 510 of the alveolar bone 500, so that certain stimulations are continuously provided to the compact bone 510 for thereby preventing any destroy of bones. An axial direction straight groove 112 is formed between the small thread parts 111 and is engaged over an area wider than the small thread part 111, so that an engagement force between the fixture 100 and the compact bone 510 is enhanced.

The non-tooth part 120 is extended from the upper end of the first straight part 110 and is formed, with the diameter of the same getting decreased in the upward direction, so that an upper structure 600b is mounted on the upper side of the same. The non-tooth part 120 prevents the formation of a surplus alveolar bone 500 during the first and second surgical operations, while preventing the surplus alveolar bone 500 from being attached to the upper side of the fixture 100. In addition, the non-tooth part 100 is only structure protruded outwards from the alveolar bone 500 after the fixture 100 is implanted. The non-tooth part 100 is preferably smaller as compared to the entire length of the fixture 100.

The first inclination part 130 is extended from the lower end of the straight part 110, with the diameter of the same getting decreased downwards. A first large thread part 131 having the same lead as the small thread part 111 is formed at an outer surface of the same and is engaged with the cancellous bone 520. Since the diameter of the first inclination part 130 increases upwards, the first inclination part 130 is more stably and widely implanted into the cancellous bone 520 as compared to the second straight part 140. The first inclination part 130 effectively distributes the loads applied to the fixture 100. An axial direction straight groove 132 is formed between the first large thread parts 131. Since the axial direction straight groove 132 is engaged over a wider area as compared to the first large thread part 131, an engagement force between the fixture 100 and the compact bone 510 is enhanced.

The second straight part 140 is extended from the lower end of the first inclination part 130, with the diameter of the same being uniform downwards. A second large thread part 141 having the same lead as the small thread part 111 is formed at an outer surface of the same and is engaged with the cancellous bone 520. An axial direction straight groove 132 is formed between the second large thread parts 141. Since the axial direction straight groove 132 is engaged over wider areas as compared to the second large thread path 141, an engagement force between the fixture 100 and the cancellous bone 520 is enhanced.

The second inclination part 150 is extended from the lower end of the second straight part 140 and includes a third large thread part 151 having the same lead as the small thread part 111 and formed at an outer surface of the same, and a cut groove 153 formed at an outer surface in which the third large thread part 151 is formed. The second inclination part 150 is engaged with the cancellous bone 520. Here, the second inclination part 150 first contacts with the alveolar bone 500 when the fixture 100 is implanted into the alveolar bone 500. The cut groove 153 has a self-tapping function when the fixture 100 is implanted into the alveolar bone 500. Preferably, three cut grooves 153 are symmetrically formed at an outer surface of the second inclination part 150. An axial direction straight groove 132 is formed between the second large thread parts 141. Since the axial direction straight groove 132 is engaged over a wider area as compared to the second large thread part 141, an engagement force between the fixture 100 and the cancellous bone 520 is more enhanced.

The inclination groove part 160 is formed within the fixture 100 and includes an inclined groove 161 formed at a certain inclination angle in a downward direction from the inner upper side of the non-tooth part 120 to the inner lower side of the first inclination part 130, with the upper structure 600b being mounted thereon, and a hexagonal part 162 formed at a lower side of the groove 161 for thereby preventing the rotation of the upper structure 600b. Here, the inclination groove part 160 is formed with a certain height corresponding to the non-tooth part 120, the first straight part 110 and the first inclination part 130. The hexagonal part 162 is preferably formed in a polygonal shape such as a hexagonal shape, an octagonal shape, or a 12-angle shape. The hexagonal part 162 is basically directed to preventing the movement of the upper structure 600b.

The straight groove part 170 is extended from the lower end of the inclination groove part 160 and connects the inclination groove part 160 and the thread groove part 180 (which will be described later).

The thread groove part 180 is extended from the lower end of the straight groove part 170 and is engaged with the threads of the upper structure 600b.

Since, the small tooth 111 and the first and second large teeth 131,141 are formed as emboss, available to install on the alveolus bone, instantly.

FIG. 8 is a view illustrating a use state of a fixture according to a second embodiment of the present invention. As shown therein, the fixture 100 is implanted into the alveolar bone 500. The non-tooth part 120 is protruded from the alveolar bone 500, and the first straight part 110 contacts with the compact bone 510. The first inclination part 130, the second straight part 140 and the second inclination part 150 contact with the cancellous bone 520.

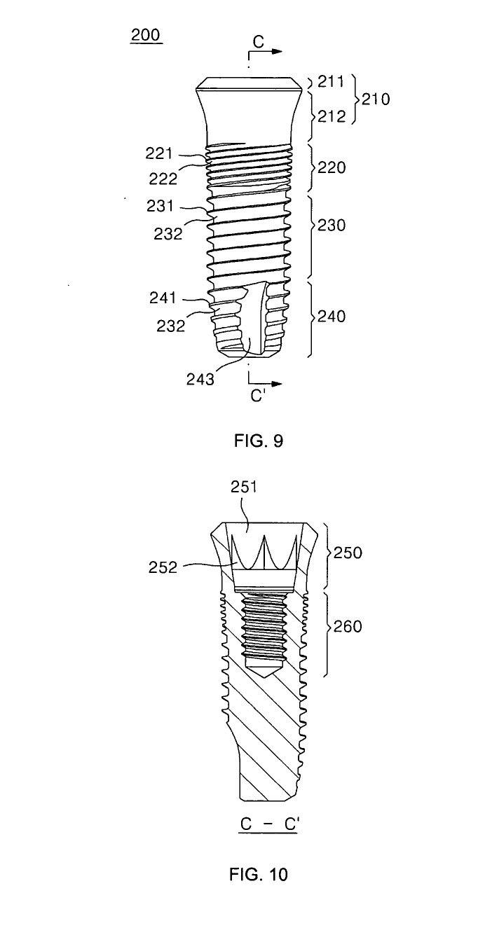

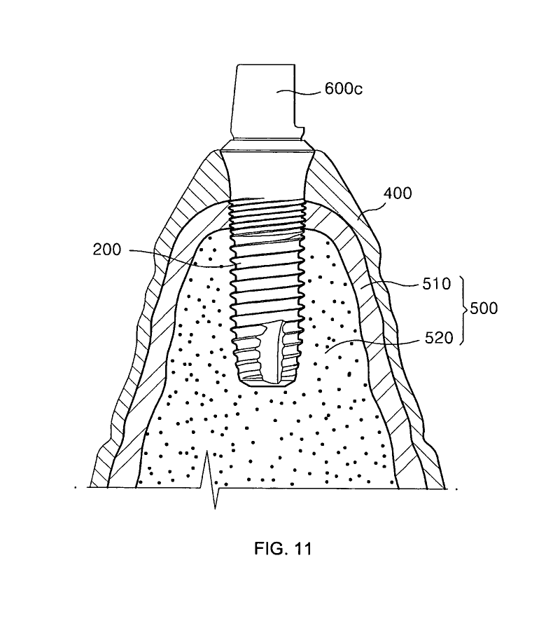

FIG. 9 is a front perspective view illustrating a fixture according to a third embodiment of the present invention, FIG. 10 is a cross sectional view taken along line C-C′ of FIG. 9, and FIG. 11 is a view illustrating a use state of a fixture according to a third embodiment of the present invention. The fixture 200 according to the present invention includes a head part 210, a third inclination part 220, a straight part 230, a fourth inclination part 240, an inclination groove part 250 and a thread groove part 260.

The head part 210 includes a first inclination part 211, with a diameter of the same getting decreased in an upward direction, and a second inclination part 212 which is extended from the lower end of the first inclination part 211, with a diameter of the same getting decreased in a downward direction. The head part 210 is protruded from an upper side of the alveolar bone 500 after the fixture 200 is implanted into the alveolar bone 500. With the protruded head part, the upper structure 600c can be easily mounted on the fixture 200 in the mouth, and a certain foreign substance can be prevented from being inputted into the engaging portions.

The third inclination part 220 is extended from the lower end of the second inclination part 212, with a diameter of the same getting decreased in a downward direction, and with a small thread part 221 being formed at an outer surface of the same. The third inclination part 220 is engaged with the compact bone 510. The small thread part 221 has the same lead as a large thread part (which will be described), so that the third inclination part 220 is tightly and stably thread-engaged with the compact bone 510. Certain stimulation is provided to the compact bone 510 for thereby preventing any destroy of bones. An axial direction straight groove 222 is formed between the small thread parts 221. The axial thread part 222 is engaged over wide areas as compared to the small thread part 221, so that an engagement force between the fixture 200 and the compact bone 510 is more enhanced.

The straight part 230 is extended from the lower end of the third inclination part 220 and has a uniform diameter. A first large thread part 231 having the same lead as the small thread part 221 is formed at an outer surface of the straight part 230, so that the straight part 230 is engaged with the cancellous bone 520. An axial straight groove 232 is formed between the first large thread parts 231. Since the axial direction straight groove 232 is engaged over wider areas as compared to the first large thread part 231, an engagement force between the fixture 200 and the cancellous bone 520 can be more enhanced.

The fourth inclination part 240 is extended from the lower end of the straight part 230, with a diameter of the same getting decreased in a downward direction, and includes a second large thread part 241 formed at an outer surface and having the same lead as the small thread part 221, and a cut groove 243 formed at an outer surface in which the second large thread part 241 is formed. With the above construction, the fourth inclination part 240 is engaged with the cancellous bone 520. The fourth inclination part 240 first contacts with the alveolar bone 500 when the fixture 200 is implanted into the alveolar 500. The cut groove 243 provides a self-tapping function when the fixture 200 is implanted into the alveolar bone 500. Preferably, four cur grooves 243 are symmetrically formed at an outer surface of the fourth inclination part 240. An axial direction straight groove 232 is formed between the second large thread parts 241. Since the axial direction straight groove 232 is engaged over wider areas as compared to the second large thread part 241, an engagement force between the fixture 200 and the cancellous bone 520 is more enhanced.

The inclination groove part 250 is formed within the fixture 200, with a diameter of the same getting decreased from the inner upper side of the first inclination part 211 to the inner lower side of the second inclination part 212, and includes an inclination groove 251 formed so that the upper structure 600c is mounted thereon, and a hexagonal part 252 which is formed at the lower side of the groove 251 and prevents the rotation of the upper structure 600c. Here, the hexagonal part 252 is preferably formed in a polygonal shape such as a hexagonal shape, an octagonal shape or a 12-angle shape. The hexagonal part 252 is basically directed to preventing the movement of the upper structure 600c after it is engaged with the upper structure 600c.

The thread groove part 260 is extended from the lower end of the inclination groove part 250 and is thread-engaged with the threads of the upper structure 600c.

Since, the small tooth 221 and the first and second large teeth 231, 241 are formed as emboss, available to install on the alveolus bone, instantly.

FIG. 11 is a view illustrating a use state of a fixture according to a third embodiment of the present invention. As shown therein, the fixture 200 is implanted into the alveolar bone 500. The head part 210 is protruded from the alveolar bone 500 and is surrounded by a gum. The third inclination part 220 contacts with the compact bone 510. The straight part 230 and the fourth inclination part 240 contact with the cancellous bone 520. In addition, the upper structure 600c is mounted on the upper side of the fixture 200.

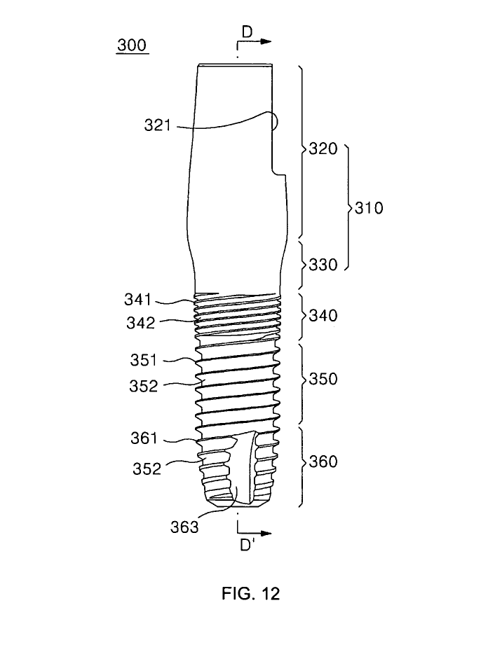

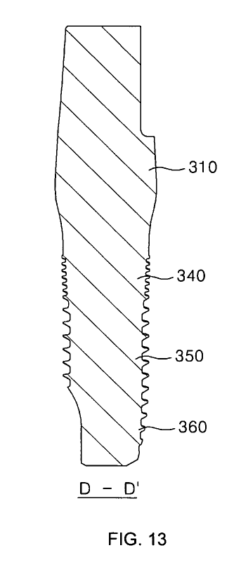

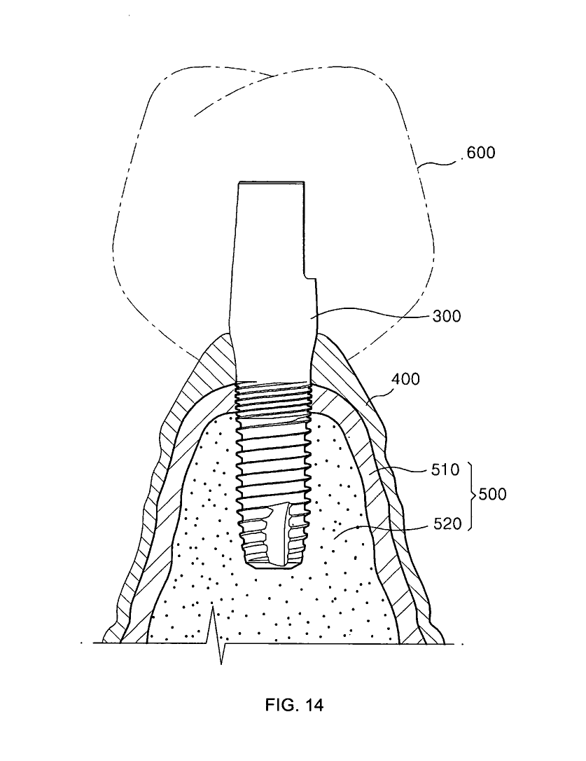

FIG. 12 is a front perspective view illustrating a fixture according to a fourth embodiment of the present invention, FIG. 13 is a cross sectional view taken along line D-D′ of FIG. 12, and FIG. 14 is a view illustrating a use state of a fixture according to a fourth embodiment of the present invention. The fixture 300 according to the present invention includes an abutment part 310, a third inclination part 340, a straight part 350 and a fourth inclination unit 360.

The abutment part 310 is formed, with a diameter of the same getting decreased in an upward direction, and includes a first inclination part 320 having at least one plane surface 321 at an upper outer surface, and a second inclination part 330 which is extended from the lower end of the first inclination part 320, with a diameter of the same getting decreased in a downward direction. The plane surface 321 is formed at an upper surface of the fixture 300, so that an engagement force between the fixture 300 and cement can be enhanced when the upper structure 600 is mounted. After the upper structure is mounted, the plane surface 321 increases an engagement with the upper structure 600 and prevents the rotation of the upper structure 600.

The third inclination part 340 is extended from the lower end of the second inclination part 330, with a diameter of the same getting decreased in a downward direction, and includes a small thread part 341 at an outer surface of the same and is engaged with the compact bone 510. Here, the small thread part 341 has the same lead as a large thread part (which will be described later), so that the third inclination part 340 is tightly and stably thread-engaged with the compact bone 510. Certain stimulations are continuously provided to the compact bone 510 for thereby preventing destroys of bones. An axial direction straight groove 342 is formed between the small thread parts 341. Since the axial direction straight groove 42 is engaged over wider areas as compared to the small thread part 341, an engagement force between the fixture 300 and the compact bone 510 can be more enhanced.

The straight part 350 is extended from the lower end of the third inclination part 340, with a diameter of the same being uniform in a downward direction, and includes a first large thread part 351 formed at an outer surface and having the same lead as the small thread part 341. With the above construction, the straight part 350 is engaged with the cancellous bone 520. An axial direction straight groove 352 is formed between the first large thread parts 351. Since the axial direction straight groove 352 is engaged over wider areas as compared to the small thread part 341, an engagement force between the fixture 300 and the compact bone 510 is more enhanced.

The fourth inclination part 360 is extended from the lower end of the straight part 350 and includes a second large thread part 361 formed at an outer surface of the same and having the same lead as the small thread part 341, and a cut groove 363 formed at an outer surface in which the second large thread part 361 is formed. With the above construction, the fourth inclination part 360 is engaged with the cancellous bone 520. The fourth inclination part 360 is first inserted into the alveolar bone 500 when the fixture 300 is implanted into the alveolar bone 500. The cut groove 363 provides a self-cutting function when the fixture 300 is implanted into the alveolar bone 500. Preferably, four cut grooves 363 are symmetrically formed at an outer surface of the fourth inclination part 360. An axial direction straight groove 352 is formed between the second large thread parts 361. Since the axial direction straight groove 352 is engaged over wider areas as compared to the second large thread part 362, an engagement force between the fixture 300 and the cancellous bone 520 is more enhanced.

Since, the small tooth 341 and the first and second large teeth 351, 361 are formed as emboss, available to install on the alveolus bone, instantly.

FIG. 14 is a view illustrating a use state of a fixture according to a fourth embodiment of the present invention. As shown therein, the fixture 300 is implanted into the alveolar bone 500. The abutment part 310 is protruded from the alveolar bone 500. The second inclination part 330 of the abutment part 310 is surrounded by a gum. The upper structure, namely, crown is mounted on the abutment part 310. The third inclination part 340 is thread-engaged with the compact bone 510, and the straight part 350 and the fourth inclination part 360 are thread-engaged with the cancellous bone 520.

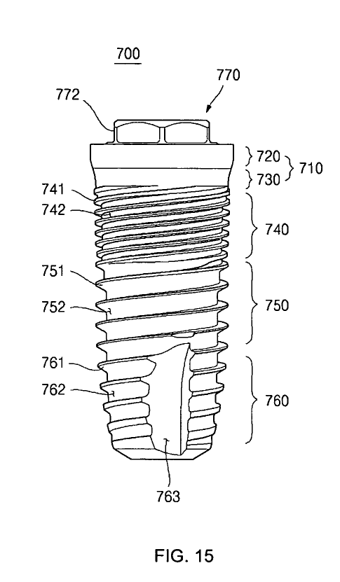

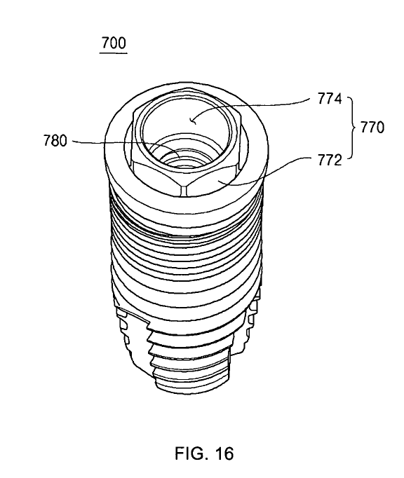

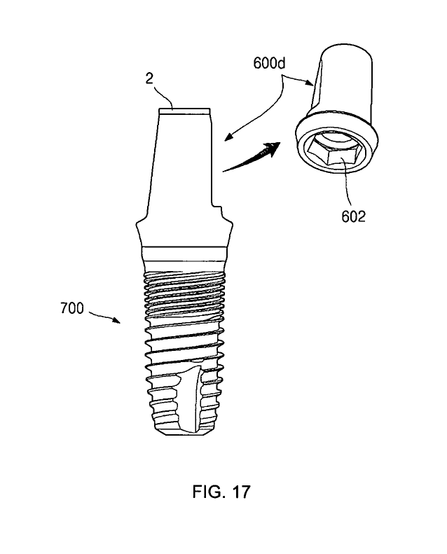

FIG. 15 is a perspective front view shows the fixing body according to the fifth embodiment of the present invention, FIG. 16 is a schematic view shows on another angle of the fixing body according to the fifth embodiment of the present invention, FIG. 17 is a schematic view of the use state of the fixing body according to the fifth embodiment of the present invention.

The fixing body 700 includes a head member 710, the third inclined member 740, a rectilinear member 750, the forth inclined member 760, a hexagon member 770, a screw thread groove member 780. The fixed body 700 according to the fifth preferred embodiment of the present invention.

The hexagon member 770 is configured as a protruded form on the outside upper portion of the head member 710, firstly, coupled with the upper structure 600d, and secondly, strictly jointed with the upper structure 600d and the fixing body 700 by a fixing screw 2, and double coupled with the fixing body 700 and the upper structure 600d.

The head member 710 of the fixing body 700 includes A cylinder member 720 formed extending in a same diameter to the direction of upper portion and a corolla figured second incline member 730 which configured the diameter thereof is decreased from the bottom, of the cylinder member 720 which extending, to the direction of the lower part thereof.

After, the fixing body 700 is implanted on the alveolus bone (not shows in drawing), the head member 710 protrudes on the upper portion of the alveolus bone (no drawing). The upper structure 600d is easy coupled on the fixing body 700 in the oral cavity, by the protruded head member 710, and, prevent the foreign materials penetration on the contracted portion.

The third inclined member 740 extends from the bottom of second inclined member 730, the small thread teeth 741 formed on the peripherals thereof, and jointed with the fine bone (no drawing).

The said small thread teeth 741 became to have a same lead with the first and second large thread tooth 751, 761 in due; the third inclined member 740 and the fine bone (no drawing) are thread coupled. And therefore, due to the above, it is occlude with the portion of the fine thick bone; besides, fine and strong coupled, prevent the bone break with a continued stimulate to the said fine bone.

The rectilinear bone 742 is formed on axle direction between the said small thread teeth 741, the rectilinear bone 742 on the axle direction is occlude with a broad area than the small thread teeth 741, further improve the coupling power between the fixing body 700 and the fine bone.

The rectilinear member 750 extends from the lower end of third inclined member 740 in a constant diameter, the first large thread teeth 751 having a same lead with the small thread teeth 741 formed on the peripheral surface and coupled with a sponge bone.

The axle direction rectilinear bone 752 formed on between the said first large thread teeth 751. The axle direction rectilinear bone 752 engaged with the broader area than, the said first large thread teeth 751, and further, improve the coupling power between, the sponge bone and the fixed body 700.

The forth inclined member 760 extends from the lower end of the rectilinear member 750, the second large thread teeth 761 formed with same lead with the small thread teeth 761, in the peripherals surface, and the cutting groove 763 formed on the peripherals surface which formed the second large thread teeth 761 then, coupled with the sponge bone.

When, the fixed body 700 plants on the alveolar bone, the forth inclined member 760 contact with the alveolar bone, at the first.

The cutting groove 763 acting in self-tapping, when, the fixing body 700 implants on the alveolar bone, and, 3 piece of the cutting grooves 763 formed, in a symmetrical figure on the surface of circumference of the forth inclined member 760.

The axle direction rectilinear bone 762 is formed between the second large thread teeth 761, the axle direction rectilinear bone 762 on the axle direction is occlude with a broad area than the second large thread teeth 761, further improve the coupling power between the fixing body 700 and the fine bone.

The hexagon member 770 is configured as a protruded form on the direction of upper side of the head member 710, in the state of completely coupled with the upper structure 600d, without produce a revolution, the protruded outer surface is formed as polygon configured of a hexagon body 772, and penetrate to the inside of the hexagon body 772 thus, includes of which formed the grooves extends to the second inclined member 730.

It is preferable, to form the said hexagon body 772 formed as polygon body exampled as a hexagon, octagon, a dodecagon, etc., and prevent the flow of the upper structure 600d.

The thread groove member 780 extends from the lower end of the hexagon member 770, coupled with the fixing screw 2 on the upper side of the upper structure 600d.

FIG. 17 is a view on a use state in detail of the fixing body according to the fifth embodiment of the present invention.

Upon the coupling of the upper construction 600d and the fixing body 700, because of the coupling groove 602 is formed on inside lower portion of the upper construction 600d to joint with the hexagon body 772 of the hexagon member 770, the hexagon body 772 is coupled with the coupling groove 602, at the first.

In the above described coupled state, a fixing screw 2 is inserted to inside of the upper construction 600d on the upper side of the upper construction 600d, the end of the fixing screw 2 coupled with the thread groove member 780 (FIG. 16) and established a strong coupling at the second.

Also, since, the small thread teeth 741 and the first and second large teeth 751,761 are formed embossed, can install on the alveolar bone, instantly.

As described above, in the present invention, a small thread part is formed at an upper side of a fixture, and a large thread part is formed at a lower side of the same, with the leads of the small and large thread parts being same, and with the small thread parts being not overlapped with each other, and with at least two thread parts being formed. When implanting a fixture into an alveolar bone, a cancellous bone with a smooth tissue contacts with a large tread portion of the fixture, so that an engagement force is enhanced. An alveolar bone contacts with a small thread part of the fixture, so that an engagement is enhanced. A bone destroy is prevented by continuously providing a certain stimulation to an alveolar bone. The fixture is stably fixed based on multi-step small thread parts. Since an upper side of the fixture is formed with a certain inclination, mixing of smooth tissue is basically prevented. A cut groove is formed at a lower side of the fixture for a self-tapping of the fixture.

In the present invention, since the abutment part is integrally formed, any danger of contamination decreases after surgical operation. The surgical operation can be performed within a short time period. Since an initial fixing time is short, the present invention can be well adapted to patients who have less bone density or small inter-teeth gaps.

Also, the small thread teeth and the first and second large teeth or the third large teeth are formed embossed, available to install on the alveolar bone, instantly in effect.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. In a fixture which becomes a root of an artificial tooth as an upper structure is mounted on the fixture, an improved fixture, comprising:
a first inclination part which has a 3° inclination angle from an upper side to a lower side and has a small thread part at an outer surface of the same and is engaged with a compact bone;
a non-tooth part which is extended from an upper end of the first inclination part and has a certain upward inclination angle, with the upper structure being mounted thereon;
a straight part which is extended from a lower end of the first inclination part and has a first large thread part formed at an outer surface of the same and having the same lead as the small thread part and is engaged with a cancellous bone;
a second inclination part which is extended from a lower end of the straight part and has a certain downward inclination angle and has the same lead as the small thread part, and a cut groove formed at an outer surface in which the second large thread part is formed, with the second inclination part being engaged with the cancellous bone;
an inclination groove part which has a 11° inclination angle from an inner upper side of the non-tooth part to an inner lower side of the first inclination part and has an inclination groove in which the upper structure is mounted, and a hexagonal part formed at a lower side of the groove and prevents the rotation of the upper structure;
a straight groove part which is extended from a lower end of the inclination groove part and supports the upper structure; and
a thread groove part which is extended from a lower end of the straight groove part and is thread-engaged with the threads of the upper structure.

2. The fixture of claim 1, wherein said non-tooth part has a 15˜45° inclination angle.

3. The fixture of claim 1, wherein said second inclination part has a 8˜15° inclination angle.

4. As claimed in claim 1, wherein, the small thread teeth and the first and second large teeth are formed embossed.

5. In a fixture which becomes a root of an artificial tooth as an upper structure is mounted on the fixture, an improved fixture, comprising:
a first straight part which has two small thread parts at an outer surface of the same and is engaged with a compact bone;
a non-tooth part which is extended from an upper end of the first straight part, with a diameter of the same getting decreased in an upward direction, and with the upper structure being mounted thereon;
a first inclination part which is extended from a lower end of the first straight part and has a first large thread part formed at an outer surface and having the same lead as the small thread part and is engaged with a cancellous bone;
a second straight part which is extended from a lower end of the first inclination part and has a second large thread part having the same lead as the small thread part and is engaged with a cancellous bone;
a second inclination part which is extended from a lower end of the second straight part and has a third large thread part having the same lead as the small thread part and a cut groove formed at an outer surface in which the third large thread part is formed and is engaged with a cancellous bone;
an inclination groove part which has an inclination groove formed from an inner upper side of the non-tooth part to an inner lower side of the first inclination part, with the upper structure being mounted thereon, and a hexagonal part formed at a lower side of the groove for thereby preventing the rotation of the upper structure;
a straight groove part which is extended from a lower end of the inclination groove part and support the upper structure; and
a thread groove part which is extended from a lower end of the straight groove part and is thread-engaged with the threads of the upper structure.

6. As claimed in claim 5, wherein, the small thread teeth and the first, second and third large teeth are formed embossed.

7. In a fixture which becomes a root of an artificial tooth as an upper structure is mounted on the fixture, an improved fixture, comprising:
a head part which includes a first inclination part extended with a diameter of the same getting decreased in an upward direction, and a second inclination part extended from a lower end of the first inclination part, with a diameter of the same getting decreased in a downward direction;
a third inclination part which is extended from a lower end of the second inclination part and has a small thread part formed at an outer surface of the same and is engaged with a compact bone;
a straight part which is extended from a lower end of the third inclination part and has a first large thread part having the same lead as the small thread part and is engaged with a cancellous bone;
a fourth inclination part which is extended from a lower end of the straight part and has a second large thread part formed at an outer surface of the same and having the same lead as the small thread part and a cut groove formed at an outer surface in which the second large thread part is formed and is engaged with a cancellous bone;
an inclination groove part which is formed with a diameter getting decreased from an inner upper side of the first inclination part to an inner lower side of the second inclination part and includes an inclination groove in which the upper structure is mounted and a hexagonal part formed at a lower side of the groove for thereby preventing the rotation of the upper structure; and
a thread groove part which is extended from a lower end of the inclination groove part and is engaged with the threads of the upper structure.

8. As claimed in claim 7, wherein, the small thread teeth and the first and second large teeth are formed embossed.

9. In a fixture which is implanted into an alveolar and becomes a root of an artificial tooth, with an upper structure being mounted thereon, a fixture, comprising:
an abutment part which is formed upwards with a diameter of the same getting decreased, and includes a first inclination part having at least plane surfaces at an upper outer surface and a second inclination part extended from a lower end of the first inclination part, with a diameter of the same getting decreased downwards;
a third inclination part which is extended from a lower end of the second inclination part and has a small thread part at an outer surface of the same and is engaged with a compact bone;
a straight part which is extended from a lower end of the third inclination part and has a first large thread part having the same lead as the small thread part and is engaged with a cancellous bone; and
a fourth inclination part which is extended from a lower end of the straight part and has a second large thread part formed at an outer surface and having the same lead as the small thread part and a cut groove formed at an outer surface, in which the second large thread part is formed, and is engaged with a cancellous bone.

10. As claimed in claim 9, wherein, the small thread teeth and the first and second large teeth are formed embossed.

11. In a fixing body which role as an artificial dental root that, implants on the alveolar bone to mount the upper construction;
a cylinder member formed and extending in a same diameter to the direction of upper portion and,
a head member having a corolla figured second incline member which configured the diameter thereof is decreased from the bottom of the cylinder member which extending, to the direction of the lower part thereof;
the third inclined member extends from the bottom of second inclined member, the small thread teeth formed on the peripherals thereof, and jointed with the fine bone;
the rectilinear member extends from the lower end of third inclined member, the first large thread teeth having a same lead with the small thread teeth formed on the peripheral surface and coupled with a sponge bone; The second large thread teeth extends from the lower end of the rectilinear member, and formed a same lead with the small thread teeth on the peripherals thereof, the forth inclined member includes the cutting groove formed on the on the peripheral surface which formed the second large thread teeth and, coupled with a sponge bone;
the hexagon member is configured as a protruded form on the direction of upper side of the head member, in the state of completely coupled with the upper structure, without produce a revolution, the protruded outer surface is formed as polygon configured of a hexagon body, and penetrate to the inside of the hexagon body thus, includes of which formed the grooves extends to the second inclined member; and
the thread groove member extends from the lower end of the hexagon member, coupled with the fixing screw on the upper side of the upper structure.

12. As claimed in claim 11, wherein, the small thread teeth and the first and second large teeth are formed embossed.
